(19) United States
(12) Patent Application Publication
(10) Pub. No.: US 2013/0061869 A1
(43) Pub. Date: Mar. 14, 2013

(54) USE OF MEGASONIC ENERGY TO ASSIST EDGE BOND REMOVAL IN A ZONAL TEMPORARY BONDING PROCESS

(71) Applicants: Jeremy McCutcheon, Rolla, MO (US); James E. Strothmann, Rolla, MO (US)

(72) Inventors: Jeremy McCutcheon, Rolla, MO (US); James E. Strothmann, Rolla, MO (US)

(73) Assignee: BREWER SCIENCE INC., Rolla, MO (US)

(21) Appl. No.: 13/605,657

(22) Filed: Sep. 6, 2012

Related U.S. Application Data
(60) Provisional application No. 61/531,155, filed on Sep. 6, 2011.

(51) Int. Cl. B08B 3/12

(52) U.S. Cl. 134/1; 134/184

(57) ABSTRACT

New methods of weakening the bonds between a bonded pair of wafers or substrates are provided. The substrates are preferably bonded at their outer peripheries. When it is desired to separate the substrates, they are contacted with a solvent system suitable for weakening, softening, and/or dissolving the bonding composition at their outer peripheries. Megasonic energy is simultaneously directed at the substrates (and preferably the bonding composition itself), so as to increase solvent penetration into the composition, thus decreasing the time needed for substrate separation and increasing throughput.

### BACKGROUND OF THE INVENTION

1. Related Applications

The present invention claims the benefit of U.S. Provisional Application No. 61/531,155, filed Sep. 6, 2011, entitled USE OF MEGASONIC ENERGY TO ASSIST EDGE BOND REMOVAL IN A ZONAL TEMPORARY BONDING PROCESS, incorporated by reference herein.

2. Field of the Invention

This invention is related to the removal of the bonding material between a wafer and carrier in a temporary bonding process.

3. Description of the Prior Art

The wafer thinning process often requires bonding a device wafer that will undergo thinning to a carrier wafer that supports the other wafer during the thinning process. In some temporary bonding schemes, such as the zonal bonding process commercialized under the name ZoneBOND® by Brewer Science, Inc. (described in U.S. Patent Application Publication No. 2009/0218560 to Flaim et al., incorporated by reference herein), the bonding material must be softened, weakened, or removed from all or part of the interface between the carrier and substrate wafer. Current methods of removing the bonding material or otherwise weakening the bond include dissolution by chemical means, decomposition by thermal means (e.g., UV or laser), softening the bonding material by thermal means (e.g., UV or laser), or physically cutting the bond by mechanical means. In zonal bonding processes such as the ZoneBOND® process, only the outer edge or periphery of the bonding material needs to be altered or removed before separation. In these cases, it is advantageous to focus the separation efforts only on the outer edge of the wafer-carrier stack. Once the bonding material at the outer edge of the stack is altered or removed, the carrier can be separated from the device wafer using low-stress, low-temperature techniques.

However, where solvent dissolution is used to remove or otherwise weaken the outer bonding zone, the bonding material removal process can take a long period of time, thus decreasing throughput. Edge cutting systems have been utilized that rotate the bonded wafer-carrier pair through a recirculating solvent bath, but such apparatuses take hours, even days, to dissolve even a thin ring of adhesive around the edge of the bonded pair. Equipment and processes are needed that are able to increase the solvent penetration between the wafer and carrier, and to increase the rate at which fresh solvent is able to contact the bonding material. This would increase throughput and save on processing time and costs.

### SUMMARY OF THE INVENTION

The present invention fills this need by providing a method of weakening the bond between a pair of substrates having a bonding layer between them. The method comprises contacting the bonding layer with a solvent system and exposing the bonding layer to megasonic energy.

In another embodiment, an apparatus for weakening the bond between a pair of substrates is provided. The apparatus comprises at least two bonded substrates and a substrate holder. The bonded substrates are positioned within the holder. There is a solvent reservoir adjacent the substrate holder, and the solvent reservoir comprises a solvent system therein. At least a portion of the bonded substrates is in contact with the solvent system. A source of megasonic energy is positioned and configured to transmit the megasonic energy through the solvent system and against the bonded substrates.

### BRIEF DESCRIPTION OF THE DRAWINGS

FIG. 1 is a schematic drawing depicting a cross-sectional view of an apparatus that can be used to practice the inventive method; and

FIG. 2 is a graph comparing the penetration depths obtained both with and without megasonic energy over time.

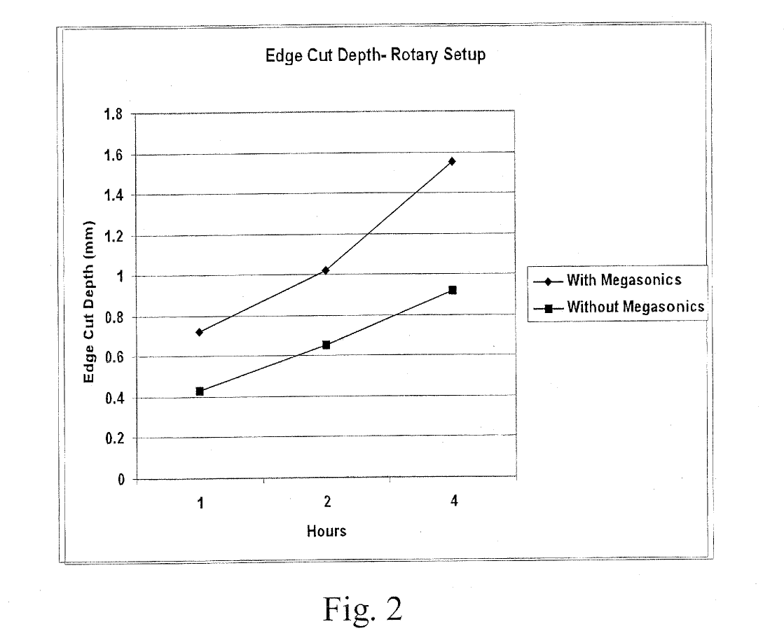

### DETAILED DESCRIPTION OF THE PREFERRED EMBODIMENTS

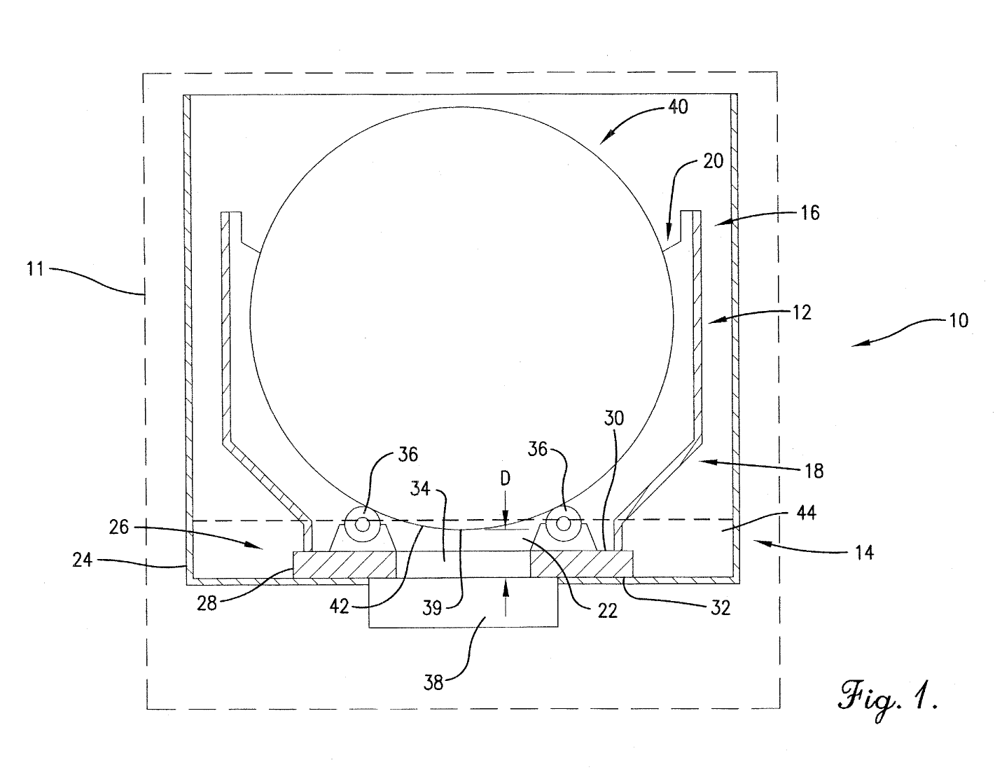

FIG. 1 shows one possible equipment configuration that can be utilized to practice the present inventive method. In this configuration, an apparatus 10 is provided. Apparatus 10 includes a housing 11, a cassette or substrate holder 12, and a lower assembly 14. Holder 12 includes upper and lower portions 16, 18. Upper portion 16 includes at least one wafer or substrate receiving slot 20, while lower portion 18 includes wafer or substrate exposing area 22.

Lower assembly 14 includes a solvent reservoir or tray 24 and a support assembly 26 positioned within the tray 24 and underneath (and supporting) holder 12. Support assembly 26 has a platform 28 having an upper surface 30 and a lower surface 32. Platform 28 further comprises an opening 34 formed therein. Support assembly 26 additionally has turning rods 36, positioned on or above upper surface 30 of platform 28. Finally, a megasonic transducer 38 is positioned below lower surface 32 of platform 28. Although conventional equipment can be configured to achieve the above, one particularly preferred arrangement involves a device sold under the name ZoneBOND® Edge Preparation Tool (Brewer Science, Inc., Rolla, Mo.), modified to be equipped with a megasonic transducer. Suitable megasonic transducers include the MegBar megasonic transducer or a Megasonic Radial-Edge transducer (ProSYS, Campbell, Calif.).

In use, a substrate or wafer pair 40 that has been previously bonded together but should now be separated is inserted into slot 20, so that a portion 42 of the pair 40 extends through and out of exposing area 22. The pair 40 can be any type of substrates typically bonded together (e.g., a device wafer bonded to a carrier wafer) that ultimately needs to be separated. Typical carrier wafers include silicon, sapphire, quartz, metals (e.g., aluminum, copper, steel), and various glasses and ceramics wafers. Typical device wafers include those whose device surfaces comprise arrays of devices (not shown) selected from the group consisting of integrated circuits, MEMS, microsensors, power semiconductors, light-emitting diodes, photonic circuits, interposers, embedded passive devices, and other microdevices fabricated on or from silicon and other semiconducting materials such as silicon-germanium, gallium arsenide, and gallium nitride. The surfaces of these devices commonly comprise structures (again, not shown) formed from one or more of the following materials: silicon, polysilicon, silicon dioxide, silicon (oxy)nitride, metals (e.g., copper, aluminum, gold, tungsten, tantalum), low k dielectrics, polymer dielectrics, and various metal nitrides and silicides. The device surface can also include at least one structure selected from the group consisting of: solder bumps; metal posts; metal pillars; and structures formed from a material selected from the group consisting of silicon, polysilicon, silicon dioxide, silicon (oxy)nitride, metal, low k dielectrics, polymer dielectrics, metal nitrides, and metal silicides.

The bonding between the pair 40 can be accomplished by any known bonding method or process. In one embodiment, the bonding can take place through a bonding layer (not shown) between the two substrates. The bonding layer can be a continuous bonding layer that extends entirely between the two substrates (be it formed of the same material all the way across or different types of bonding materials), but in the most preferred embodiment, the bonding layer is a zonal-type bonding layer. That is, it is preferred that the bonding composition is limited to the outer perimeters of the pair 40. Preferred bonding configurations can be found in U.S. Patent Application Publication Nos. 2009/0218560 to Flaim et al. and 2012/0034437 to Puligadda et al., each incorporated by reference herein.

Preferably, the average distance that the bonding composition extends from the outer perimeter of the pair 40 inward toward the central region of the pair (i.e., the bonding composition's width) is from about 0.25 mm to about 15 mm, more preferably from about 0.5 mm to about 10 mm, and even more preferably from about 1 mm to about 5 mm. The average thickness (taken over five measurements) of the bonding composition between the two wafers is preferably from about 5 μm to about 100 μm, more preferably from about 10 μm to about 75 μm, and even more preferably from about 20 μm to about 50 μm. If multiple bonding layers are utilized, it is preferred that the sum of their average thicknesses fall within the above range.

Anything with an adhesion strength of greater than about 50 psig, preferably from about 80 psig to about 250 psig, and more preferably from about 100 psig to about 150 psig, would be desirable for use as the bonding composition. As used herein, adhesion strength is determined by ASTM D4541/D7234. The bonding composition utilized can be any commercially available bonding composition that is capable of achieving these adhesion strengths, and of being removed via a solvent removal process. Typical such compositions are organic and will comprise a polymer or oligomer dissolved or dispersed in a solvent system. The polymer or oligomer is preferably selected from the group consisting of polymers and oligomers of cyclic olefins, epoxies, acrylics, silicones, styrenics, vinyl halides, vinyl esters, polyamides, polyimides, polysulfones, polyethersulfones, cyclic olefins, polyolefin rubbers, and polyurethanes, ethylene-propylene rubbers, polyamide esters, polyimide esters, polyacetals, and polyvinyl butyral. Suitable solvent systems will depend upon the polymer or oligomer selection. Typical solids contents of the compositions will range from about 1% to about 60% by weight, and preferably from about 3% to about 40% by weight, based upon the total weight of the composition taken as 100% by weight. Some preferred compositions are described in U.S. Patent Publication Nos. 2007/0185310, 2008/0173970, 2009/0038750, and 2010/0112305, each incorporated by reference herein.

As shown in FIG. 1, tray 24 is filled with one or more solvents 44, so that portion 42 is submerged in the solvent 44. The immersion depth can be adjusted from about 0.1 mm to about 30 mm. Suitable solvents include any solvent that will weaken, soften, or remove the outer material in the bonding zone without damaging the surface of the carrier or substrate wafer. Solvents that could be used during this removal process include those selected from the group consisting of ethyl lactate, cyclohexanone, N-methyl pyrrolidone, aliphatic solvents (e.g., hexane, decane, dodecane, and dodecane), ketones, nonpolar solvents (e.g., r-limonene, mesitylene), acids (e.g., HCl, acetic acid), bases (e.g., KOH), and mixtures thereof. Examples of such suitable solvents are sold under the names WaferBOND® Remover and ZoneBOND® Remover 2112 (Brewer Science, Inc., Rolla, Mo.). Another preferred solvent comprises an alkylarylsulfonic acid and an aliphatic alcohol dispersed or dissolved in a hydrocarbon solvent system, such as that described in U.S. patent application Ser. No. 13/196,679 to Zhong (U.S. Patent Application Publication No. ______), incorporated by reference herein.

Rods 36, which are electrically or pneumatically driven, are capable of lifting the bonded pair 40 out of the holder 12, while leaving them engaged in the slot 20. The rods 36 turn against the edges of the pair 40 so as to cause them to rotate, thus exposing different portions 42 of pair 40 to the solvent 44 over time. The preferred rotation speeds depend upon the particular requirements, but are typically from about 0.1 rpm to about 30 rpm, and preferably from about 1 rpm to about 20 rpm.

While the pair 40 is being exposed to the solvent 44, the megasonic transducer 38 is powered on, so that megasonic energy is transmitted through the solvent 44 and to the exposed portions 42 of bonded pair 40. Use of megasonic energy enhances the penetration of solvent into the bonding composition. The frequency utilized typically varies from about 0.4 MHZ to about 5 MHZ, and preferably from about 0.8 MHZ, to about 2 MHZ, depending upon the dissolution parameters. Additional parameters can be controlled and adjusted, depending upon the particular application. Some typical ranges include: power density (from about 0.001 Watts/cm² to about 5 Watts/cm²), rotation speed (from about 0.01 rpm to about 100 rpm), solvent level (from about 0.1% to about 100%), and solvent exchange flow (from about 0.1% per hour to about 100% per hour). Furthermore, the position of transducer 38 and/or the pair 40 can be adjusted so that the distance “D,” which is the distance from the lowermost point 39 on the pair 40 to the top of the transducer 38, is varied depending upon the particular circumstances. Typical distances “D” will be from about 0.1 mm to about 20 mm, and more preferably from about 0.5 mm to about 5 mm. It will be appreciated that the presence of opening 34 allows for the adjustment of this distance “D.”

Advantageously, this focused application of megasonic energy improves and aids in the chemical dissolution of the perimeter bonding composition. That is, the integrity of the bond is weakened, softened, and/or partially dissolved, and at an increased rate as compared to solvent use alone. More particularly, debonding according to the present invention will result in edge bond cut rates of from about 0.1 mm per hour of solvent/megasonic energy contact to about 5 mm per hour of solvent/megasonic energy contact; preferably from about 0.5 mm per hour of solvent/megasonic energy contact to about 4 mm per hour of solvent/megasonic energy contact; and more preferably from about 1 mm per hour of solvent/megasonic energy contact to about 3 mm per hour of solvent/megasonic energy contact. This is typically an increase of at least about 0.1 mm per hour, preferably at least about 0.2 mm per hour, and more preferably from about 0.3 mm to about 1 mm per hour compared to the use of the same solvent and other conditions but without megasonic energy application. These distances are measured as described in the Examples section below.

Once the bond has been weakened, the substrate pair 40 can be separated from one another using any typical separation tool (e.g., slide debond, lift-off debond, ZoneBOND® Separation Tool from Brewer Science, Inc.), cleaned, and further processed, depending upon the final intended use.

The inventive method has been described above and in FIG. 1 to show a preferred apparatus 10 for carrying out the method. However, it will be appreciated that numerous modifications can be made to carry out the same method. That is, as long as the edge bond is exposed substantially simultaneously to both the desired solvent and megasonic energy, the equipment is not critical. For example, although the above described solvent contact occurred by rotating the bonded pair 40 through the solvent 44, solvent contact could be effected via a static or agitated solvent bath. Alternatively, solvent contact could be accomplished via spraying or otherwise dynamically applying the solvent to the outer edge of the pair 40. In some equipment set-ups, it may be preferred to keep the pair 40 stationary while rotating the transducer 38.

As another possible variation, the transducer 38 could be positioned next to the pair 40 or above the pair 40, rather than underneath the pair 40, provided it is able to focus the megasonic energy towards the correct location on the bonded pair 40 (i.e., at the edge where the bonding composition is present). Also, if the transducer 38 can be positioned to cover the entire circumference of the pair 40, then there would not be a need to rotate pair 40.

As another possible variation, the bonded pair 40 could be entirely submerged in the solvent 44. In such instances, rotation may or may not be required, depending upon the selection and orientation of the transducer 38. Furthermore, while FIG. 1 only shows one bonded pair 40 being processed, a typical cassette holder 12 would be able to simultaneously support several pairs 40, and that is intended to be covered, and actually preferred, in the present invention. Additionally, the method could be used to debond more than two substrates bonded together.

### EXAMPLES

The following examples set forth preferred methods in accordance with the invention. It is to be understood, however, that these examples are provided by way of illustration and nothing therein should be taken as a limitation upon the overall scope of the invention.

### Example 1

### Using Megasonic Energy to Assist in Edge Cutting Zonal Edge Bond Material

A 1-μm thick by 3-5 mm wide layer of ZoneBOND® 5150 material (Brewer Science, Inc., Rolla, Mo.) was coated onto the surface of a 200-mm silicon wafer (carrier) at the outer edge. This wafer was baked at 80° C. for 2 minutes followed by 120° C. for 2 minutes and finally 220° C. for 2 minutes. A fluorinated silane ((heptadecafluoro-1,1,2,2-tetrahydradecyl) trichlorosilane) was diluted to a 1% solution using FC-40 solvent (perfluoro compound with primarily C₁₂, sold under the name Fluorinert, obtained from 3M). The solution was spin coated onto the center section of the carrier. The carrier was baked on a hotplate at 100° C. for 1 minute, rinsed with FC-40 solvent in a spin coater, and baked on a hotplate at 100° C. for an additional 1 minute.

The surface of another 200-mm silicon wafer (simulated device wafer) was coated with a 50-μm thick layer of ZoneBOND® 5150 material via spin coating. This wafer was baked at 80° C. for 2 minutes followed by 120° C. for 2 minutes and finally 220° C. for 2 minutes. The device and carrier were bonded in a face-to-face relationship under vacuum at 220° C. for 3 minutes in a heated vacuum and pressure chamber.

The bonded pair was placed into a Brewer Science Inc. ZoneBOND® Edge Preparation tool equipped with a megasonic transducer. The transducer was mounted in the bottom of a solvent bowl and could be turned on or off selectively. The tool rotated the bonded pair through solvent (ZoneBOND® Remover 2112) in a perpendicular orientation to the megasonic transducer to soften and partially dissolve the material between the carrier and device wafers at the edge. Samples were run with and without 100 W of megasonic energy for 1, 2, and 4 hours. Then the carrier was separated from each assembly using a ZoneBOND® Separation Tool. The width of solvent penetration was measured using a micro ruler and 1.5× microscope. FIG. 1 summarizes the penetration depth with and without the megasonic energy over time.

### Example 2

### Using Megasonic Energy to Assist in Edge Cutting

A 30-μm layer of ZoneBOND® 5150-30 material (Brewer Science, Inc., Rolla, Mo.) was coated onto the surface of a 150-mm silicon wafer (simulated device wafer). This wafer was baked at 80° C. for 2 minutes followed by 120° C. for 2 minutes and finally 220° C. for 2 minutes. The coated silicon wafer was then bonded to a 150-mm glass carrier in a face-to-face relationship under vacuum at 220° C. for 3 minutes in a heated vacuum and pressure chamber. Both the silicon and glass wafers had a flat edge on one side, and the flat edges were aligned. This was repeated five more times to produce 6 bonded pairs.

A simulated edge cut apparatus was then assembled comprising a solvent bath filled with ZoneBOND® Remover 2112 to dissolve the ZoneBOND® 5150-30 material (Brewer Science). The solvent bath was equipped with a thermometer placed 1 inch deep in the solvent. The wafers were then submerged vertically in the solvent bath. In the first run, three of the wafers were processed in solvent plus megasonic energy. In the second run, three wafers were processed in solvent with the addition of megasonic energy. In the third run, two wafers were processed in solvent plus megasonic energy. Each run used the same solvent. The third run was performed to confirm that the solvent was not saturated, causing the slower solubility seen in the second round without megasonic energy. When megasonic energy was used, a MegBar (Prosys, Campbell, Calif,) was placed parallel to the flats on the bonded pair, held apart by 0.7 mm. The MegBar was set to a 20-ms pulse, 100% duty cycle, 100 W power, with cooling nitrogen set at 5 psi.

The temperature was tracked for each wafer. The tables below show the temperature reading for a wafer processed with megasonic energy (Table 1), and a wafer processed without megasonic energy (Table 2).

TABLE 1

| MINUTES | RTD1 (° C.)* | RTD2 (° C.)* | BATH TEMP (° C.) |
|---|---|---|---|
| 0 | 20 | 20 | 20 |
| 5 | 38 | 37 | 21 |
| 10 | 46 | 47 | 22 |
| 15 | 54 | 54 | 23 |
| 20 | 60 | 59 | 24 |
| 25 | 64 | 64 | 24.5 |
| 30 | 66 | 65 | 25 |

*Internal temperature of megasonic generator.

TABLE 2

| MINUTES | BATH TEMP (° C.) |
|---|---|
| 0 | 26 |
| 5 | 25 |
| 10 | 24.5 |
| 15 | 24 |
| 20 | 23.5 |
| 25 | 23 |
| 30 | 23 |

The width of solvent penetration of each wafer at three points was measured using a micrometer and 5× microscope. Table 3 shows the average penetration depth in millimeters.

TABLE 3

| With Megasonics | | | Without Megasonics | | | With Megasonics | |
|---|---|---|---|---|---|---|---|
| Wafer #1 | Wafer #2 | Wafer #3 | Wafer #1 | Wafer #2 | Wafer #3 | Wafer #4 | Wafer #5 |

| | | | | | | | |
|---|---|---|---|---|---|---|---|
| 1 | 0.8 | 0.8 | 0.7 | 0.8 | 0.5 | 1 | 1 |
| 1 | 1 | 0.7 | 0.7 | 0.8 | 0.6 | 0.9 | 1.1 |
| 0.9 | 0.8 | 0.7 | 0.7 | 0.8 | 0.5 | 0.9 | 1 |
| Average | Average | Average | Average | Average | Average | Average | Average |
| 0.97 | 0.87 | 0.73 | 0.7 | 0.8 | 0.53 | 0.93 | 1.03 |

| | | | | | |
|---|---|---|---|---|---|
| Average Total | 0.86 | Average Total | 0.68 | Average Total | 0.98 |

We claim:

1. A method of weakening the bond between a pair of substrates having a bonding layer between them, said method comprising:
contacting said bonding layer with a solvent system; and
exposing said bonding layer to megasonic energy.

2. The method of claim 1, wherein said contacting and exposing occur substantially simultaneously.

3. The method of claim 1, wherein said megasonic energy is applied to said solvent system and is transferred through said solvent system to the bonding layer.

4. The method of claim 1, wherein said megasonic energy is applied at a frequency of from about 0.4 MHZ to about 5 MHZ.

5. The method of claim 1, said substrate pair having respective outer peripheries, wherein during said contacting only a portion of said outer peripheries is being contacted with said solvent at a time.

6. The method of claim 5, wherein said substrate pair is rotated through said solvent during said contacting.

7. The method of claim 1, said substrate pair having respective outer peripheries and respective central regions, wherein said bonding layer is present at said outer peripheries.

8. The method of claim 7, wherein said bonding layer is absent from said central regions.

9. The method of claim 1, wherein said contacting and exposing result in a weakening of the bonding layer.

10. The method of claim 1, wherein said contacting and exposing result in edge bond cutting at a rate of from about 0.1 mm per hour of solvent/megasonic energy contact to about 5 mm per hour of solvent/megasonic energy contact.

11. The method of claim 1, further comprising separating said substrate pair from one another.

12. The method of claim 1, wherein said bonding layer is formed from a composition comprising a polymer or oligomer dissolved or dispersed in a solvent system, said polymer or oligomer being selected from the group consisting of polymers and oligomers of cyclic olefins, epoxies, acrylics, silicones, styrenics, vinyl halides, vinyl esters, polyamides, polyimides, polysulfones, polyethersulfones, cyclic olefins, polyolefin rubbers, and polyurethanes, ethylene-propylene rubbers, polyamide esters, polyimide esters, polyacetals, and polyvinyl butyral.

13. The method of claim 1, wherein said solvent system comprises a solvent selected from the group consisting of ethyl lactate, cyclohexanone, N-methyl pyrrolidone, aliphatic solvents, ketones, nonpolar solvents, acids, bases, and mixtures thereof.

14. An apparatus for weakening the bond between bonded substrates, said apparatus comprising:
at least two bonded substrates;
a substrate holder, said bonded substrates being positioned within said holder;
a solvent reservoir adjacent said substrate holder, said solvent reservoir comprising a solvent system therein, and at least a portion of said bonded substrates being in contact with said solvent system; and
a source of megasonic energy positioned and configured to transmit the megasonic energy through said solvent system and against said bonded substrates.

15. The apparatus of claim 14, wherein said bonded substrates include:
a carrier wafer selected from the group consisting of silicon, sapphire, quartz, metals, glass, and ceramics wafers; and
a device wafer whose surface comprises an array of devices selected from the group consisting of integrated circuits, MEMS, microsensors, power semiconductors, light-emitting diodes, photonic circuits, interposers, embedded passive devices.

16. The apparatus of claim 14, said bonded substrates having respective outer peripheries and respective central regions and being bonded by a bonding layer that is present at said outer peripheries.

17. The apparatus of claim 16, wherein said bonding layer is absent from said central regions.

18. The apparatus of claim 14, said bonded substrates being bonded by a bonding layer that is formed from a composition comprising a polymer or oligomer dissolved or dispersed in a solvent system, said polymer or oligomer being selected from the group consisting of polymers and oligomers of cyclic olefins, epoxies, acrylics, silicones, styrenics, vinyl halides, vinyl esters, polyamides, polyimides, polysulfones, polyethersulfones, cyclic olefins, polyolefin rubbers, and polyurethanes, ethylene-propylene rubbers, polyamide esters, polyimide esters, polyacetals, and polyvinyl butyral.

19. The apparatus of claim 14, wherein said solvent system comprises a solvent selected from the group consisting of ethyl lactate, cyclohexanone, N-methyl pyrrolidone, aliphatic solvents, ketones, nonpolar solvents, acids, bases, and mixtures thereof.
